(19) United States
(12) Patent Application Publication
(10) Pub. No.: US 2015/0050546 A1
(43) Pub. Date: Feb. 19, 2015

(54) POSITIVE ELECTRODE ACTIVE MATERIAL FOR NON-AQUEOUS ELECTROLYTE SECONDARY BATTERY AND NON-AQUEOUS ELECTROLYTE SECONDARY BATTERY USING SAID POSITIVE ELECTRODE ACTIVE MATERIAL

(71) Applicant: SANYO Electric Co., Ltd., Moriguchi-shi, Osaka (JP)

(72) Inventors: Akihiro Kawakita, Hyogo (JP); Takeshi Ogasawara, Hyogo (JP)

(73) Assignee: SANYO Electric Co., Ltd., Moriguchi-shi, Osaka (JP)

(21) Appl. No.: 14/388,034

(22) PCT Filed: Mar. 5, 2013
(86) PCT No.: PCT/JP2013/055936

§ 371 Date: Sep. 25, 2014

(30) Foreign Application Priority Data
Mar. 28, 2012 (JP) 2012-074320

(51) Int. Cl. H01M 4/36; H01M 10/0525; H01M 4/525; H01M 4/131; H01M 4/505

(52) U.S. Cl. CPC H01M 4/366; H01M 4/131; H01M 4/505; H01M 4/525; H01M 10/0525; H01M 2004/028
USPC 429/162; 429/223

(57) ABSTRACT

Even when a battery is produced with a positive electrode active material or a positive electrode containing the positive electrode active material after exposure to the air, battery properties such as a charge storage property can be significantly enhanced. Included are a lithium transition metal compound oxide at least containing nickel and manganese such that the nickel is contained in a higher content than the manganese in terms of moles; and sodium fluoride adhering to a surface of the lithium transition metal compound oxide. The lithium transition metal compound oxide may contain cobalt.

### TECHNICAL FIELD

The present invention relates to, for example, a positive electrode active material for a non-aqueous electrolyte secondary battery.

### BACKGROUND ART

In recent years, the size and weight of mobile information terminals such as cellular phones, notebook computers, and smart phones have been rapidly reduced. Batteries serving as driving power sources of mobile information terminals are required to have an even higher capacity. Non-aqueous electrolyte secondary batteries that are charged and discharged by movements of lithium ions between the positive and negative electrodes during charging and discharging have a high energy density and a high capacity and hence are widely used as driving power sources of the above-described mobile information terminals.

Such mobile information terminals, which have come to be equipped with functions such as a video playback function and a gaming function, tend to have an even higher power consumption and hence there is a strong demand for further increasing the capacity. In order to increase the capacity of the above-described non-aqueous electrolyte secondary batteries, for example, it was proposed to use a Ni—Co—Mn lithium compound oxide or a Ni—Co—Al lithium compound oxide having a high Ni content. In addition, in order to address various challenges in the case of using such positive electrode active materials, the following proposals were made.

(1) A proposal in which a pulse voltage of 4.4 to 4.5 V is applied to, in a battery-case open state, a battery containing layered lithium nickel oxide as the positive electrode active material, and the case is subsequently sealed, to thereby enhance the performance of the battery containing the nickel-based compound as the positive electrode active material (refer to Patent Literature 1 below).
(2) A proposal in which a positive electrode active material is covered with a fluoride such as aluminum fluoride, zinc fluoride, or lithium fluoride such that the weight ratio of the metal atom of the fluoride to the positive electrode active material is 0.1% to 10%, to thereby suppress a side reaction of an electrolyte at the surface of the positive electrode active material (refer to Patent Literature 2 below).
(3) A proposal in which at least one member within a battery can is prepared so as to contain sodium fluoride or the like, to thereby suppress effects of HF derived from water present in a small amount within the battery (refer to Patent Literature 3 below).

### CITATION LIST

### Patent Literature

PTL 1: Japanese Published Unexamined Patent Application No. 2005-235624
PTL 2: Japanese Published Unexamined Patent Application (Translation of PCT Application) No. 2008-536285
PTL 3: Japanese Published Unexamined Patent Application No. 8-321326

### SUMMARY OF INVENTION

### Technical Problem

However, in the case of using, as a positive electrode active material, a lithium transition metal compound oxide containing nickel and manganese such that the nickel is contained in a higher content than the manganese in terms of moles, in spite of employment of the proposals (1) to (3), a problem of generation of a large amount of gas occurs during storage of a charged battery produced with the positive electrode active material or a positive electrode containing the positive electrode active material after exposure to the air.

### Solution to Problem

According to the present invention, included are a lithium transition metal compound oxide at least containing nickel and manganese such that the nickel is contained in a higher content than the manganese in terms of moles; and sodium fluoride adhering to a surface of the lithium transition metal compound oxide.

### Advantageous Effects of Invention

According to the present invention, even when a battery is produced with a positive electrode active material or a positive electrode containing the positive electrode active material after exposure to the air, degradation of the charge storage property can be suppressed, which is advantageous.

### BRIEF DESCRIPTION OF DRAWINGS

FIG. 1 is a front view of a non-aqueous electrolyte secondary battery according to an embodiment of the present invention.

FIG. 2 is a section viewed in the direction of the arrows of line A-A in FIG. 1.

FIG. 3 is an explanatory view of a three-electrode cell.

FIG. 4 is a graph illustrating, regarding Batteries A1, A2, Z, Y1, and Y2, the relationship between the number of days of air exposure and the increase in the battery thickness.

### DESCRIPTION OF EMBODIMENTS

A positive electrode active material according to the present invention contains a lithium transition metal compound oxide at least containing nickel and manganese such that the nickel is contained in a higher content than the manganese in terms of moles; and sodium fluoride adhering to a surface of the lithium transition metal compound oxide.

In a lithium transition metal compound oxide in which the nickel content is higher than the manganese content in terms of moles, trivalent nickel is present. In such a case where trivalent nickel is present, exposure of the lithium transition metal compound oxide to the air during the battery production step causes a reaction between the lithium transition metal compound oxide and water (exchange between Li and H occurs). Accordingly, lithium hydroxide is generated or this lithium hydroxide further reacts with carbon dioxide in the air to generate lithium carbonate. In such a case where lithium oxide or lithium carbonate is present on the surface of the lithium transition metal compound oxide (in the case where the lithium transition metal compound oxide forms secondary particles provided by aggregation of primary particles, lithium oxide or lithium carbonate may be present not only on the surfaces of the secondary particles but also in the interfaces between the primary particles), gas is generated within the battery due to self decomposition or a reaction with the electrolyte during charge storage or the like, which results in degradation of the charge storage property. In order to avoid such disadvantage, electrode storage or battery production may be performed in a dry-air atmosphere from which moisture in the air has been removed. However, in order to provide the dry-air atmosphere, large-scale equipment is required, which results in an increase in the battery production cost.

In contrast, in a case where sodium fluoride adheres to the surface of the lithium transition metal compound oxide, even when the lithium transition metal compound oxide containing trivalent nickel is exposed to the air, the reaction between the lithium transition metal compound oxide and water can be suppressed. Accordingly, generation of lithium hydroxide or lithium carbonate can be suppressed, so that generation of gas within the battery can be suppressed during charge storage or the like. The reason for this is probably as follows. When sodium fluoride adheres to the surface of the lithium transition metal compound chemical compound, water is selectively adsorbed onto sodium fluoride, which is soluble in water, to thereby suppress the reaction between the lithium transition metal compound oxide and water.

With consideration of the foregoing, adhesion of sodium fluoride desirably occurs, not in a localized manner in portions of the surface of the lithium transition metal compound oxide, but as a uniform distribution over the surface of the lithium transition metal compound oxide.

In addition, employment of the above-described configuration eliminates the necessity of performing electrode storage or battery production in a dry-air atmosphere, so that reduction in the battery production cost can be achieved.

The ratio of sodium fluoride to the lithium transition metal compound oxide is preferably 0.001% by mass or more and 3% by mass or less, in particular, preferably 0.01% by mass or more and 1% by mass or less. In the case where the ratio is less than 0.001% by mass, the amount of sodium fluoride is so low that the effect is not sufficiently provided. On the other hand, when the ratio is more than 3% by mass, the amount of the active material itself (lithium transition metal compound oxide) that can contribute to the charge-discharge reaction is decreased, which results in a decrease in the battery capacity.

In addition, the sodium fluoride preferably has an average particle size of 1 nm or more and 1 μm or less, in particular, more preferably 1 nm or more and 200 nm or less. The reason for this is as follows. When the average particle size is less than 1 nm, the surface of the lithium transition metal compound oxide is excessively covered so that the electron conductivity is decreased and hence the discharge performance may be degraded. On the other hand, when the average particle size is more than 1 μm, sodium fluoride particles are so large that they are non-uniformly distributed over the surface of the lithium transition metal compound oxide. For this reason, the reaction between the lithium transition metal compound oxide and water may become difficult to suppress. Note that the average particle size is a value obtained by observation with a scanning electron microscope (SEM).

A process of making sodium fluoride adhere to the surface of the lithium transition metal compound oxide is, for example, as follows: a process of mixing the lithium transition metal compound oxide with an aqueous solution containing dissolved sodium fluoride; or a process of dropping the aqueous solution in the lithium transition metal compound oxide being stirred or spraying the aqueous solution onto the lithium transition metal compound oxide being stirred, and a subsequent drying process using a heat treatment, vacuum drying, or combination thereof.

In the case of performing the heat treatment, the temperature is preferably 80° C. or more and 500° C. or less. When the heat treatment is performed at a temperature of more than 500° C., an exchange reaction occurs between fluorine of sodium fluoride adhering to the surface and oxygen of the lithium transition metal compound oxide. When the reaction occurs, the reaction between the lithium transition metal compound oxide and water cannot be suppressed. On the other hand, when the temperature is less than 80° C., drying is difficult to achieve and takes long hours, resulting in an increase in the production cost.

The lithium transition metal compound oxide desirably contains cobalt.

In addition, the ratio of the nickel to the total transition-metal amount of the lithium transition metal compound oxide is desirably 50 mol % or more.

When the ratio of the nickel to the total transition-metal amount of the lithium transition metal compound oxide is 50 mol % or more, the discharge capacity can be increased. Note that an increase in the nickel ratio results in an increase in the amount of trivalent nickel. However, as in the above-described configuration, sodium fluoride is present on the surface of the lithium transition metal compound oxide and hence generation of gas can be suppressed.

A battery according to the present invention includes a positive electrode containing the above-described positive electrode active material; a negative electrode containing a negative electrode active material; a separator disposed between the positive electrode and the negative electrode; and a non-aqueous electrolyte.

In addition, an electrode assembly including the positive electrode, the negative electrode, and the separator desirably has a flat form.

In general, a casing for a battery including a battery assembly having a flat form is a flexible casing (an aluminum laminate film casing or a thin metal casing). Accordingly, generation of gas within the battery tends to result in deformation of the casing. Thus, the present invention is more effectively applied to such batteries whose casings tend to deform.

(Other features)
(1) In the lithium transition metal compound oxide, a substance such as Al, Mg, Ti, or Zr may be contained in the grain boundaries or may be dissolved. On the surface, a compound of a rare earth element, Al, Mg, Ti, Zr, or the like may be fixed. This is because such a fixed compound allows further suppression of a side reaction of the electrolyte at the positive electrode during charge storage.
(2) In the case where lithium nickel manganese oxide is used as the lithium transition metal compound oxide, the molar ratio of nickel and manganese is, for example, 55:45, 6:4, or 7:3. In the case where lithium nickel cobalt manganese oxide is used as the lithium transition metal compound oxide, the molar ratio of nickel, cobalt, and manganese is, for example, 5:3:2, 5:2:3, 55:15:30, 55:20:25, 6:2:2, 7:1:2, 7:2:1, 8:1:1, 90:5:5, or 95:2:3, which are publicly known compositions.
(3) A solvent of a non-aqueous electrolyte used for the present invention is not limited and solvents having been used to date for non-aqueous electrolyte secondary batteries can be used. Examples of the solvents include cyclic carbonates such as ethylene carbonate, propylene carbonate, butylene carbonate, and vinylene carbonate; linear carbonates such as dimethyl carbonate, methyl ethyl carbonate, and diethyl carbonate; ester-containing compounds such as methyl acetate, ethyl acetate, propyl acetate, methyl propionate, ethyl propionate, and γ-butyrolactone; sulfonic-group-containing compounds such as propanesultone; ether-containing compounds such as 1,2-dimethoxyethane, 1,2-diethoxyethane, tetrahydrofuran, 1,2-dioxane, 1,4-dioxane, and 2-methyltetrahydrofuran; nitrile-containing compounds such as butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile; and amido-containing compounds such as dimethylformamide. In particular, such solvents in which H's are partially replaced by F's are preferably used. Such solvents can be used alone or in combination. In particular, preferred are a solvent of a combination of a cyclic carbonate and a linear carbonate, and such a solvent that further contains a small amount of a nitrile-containing compound or an ether-containing compound.

On the other hand, a solute of the non-aqueous electrolyte may be a solute having been used to date. Examples of the solute include LiPF₆, LiBF₄, LiN(SO₂CF₃)₂, LiN(SO₂C₂F₅)₂, and LiPF₆₋ₓ(CₙF₂ₙ₋₁)ₓ [where 1<x<6, n=1 or 2]. These solutes may be used alone or in combination of two or more thereof. The concentration of the solute is not particularly limited and is desirably 0.8 to 1.5 moles per liter of the electrolyte.

(4) A negative electrode used for the present invention may be a negative electrode having been used to date. The negative electrode may be formed of, in particular, a carbon material that can occlude or release lithium, a metal that can form alloy with lithium, or an alloy compound containing the metal.

Examples of the carbon material include graphites such as natural graphite, non-graphitizing carbon, and synthetic graphite, and cokes. Examples of the alloy compound include a compound containing at least one metal that can form alloy with lithium. In particular, the metal that can form alloy with lithium is preferably silicon or tin; or a compound between such a metal and oxygen such as silicon oxide or tin oxide may be used. Alternatively, it is possible to use a mixture of the carbon material and a compound of silicon or tin.

Alternatively, though the energy density is decreased, the negative electrode material may be a substance such as lithium titanium oxide that has a higher charge-discharge potential with respect to metal lithium than carbon materials and the like.

(5) A layer composed of an inorganic filler having been used to date can be formed at the interface between the positive electrode and the separator or at the interface between the negative electrode and the separator. Examples of the filler include fillers having been used to date, such as oxides and phosphate compounds of one or more selected from titanium, aluminum, silicon, magnesium, and the like, and such oxides and phosphate compounds whose surfaces are treated with hydroxides or the like.

Such a filler layer can be formed by, for example, a method in which filler-containing slurry is directly applied to the positive electrode, the negative electrode, or the separator; or a method in which a sheet formed of filler is bonded to the positive electrode, the negative electrode, or the separator.

(6) A separator used for the present invention may be a separator having been used to date. Specifically, the separator is not limited to a separator formed of polyethylene and may be a separator in which a polypropylene layer is formed on a surface of a polyethylene layer, or a separator in which a resin such as an aramid resin is applied to a surface of a polyethylene separator.
(7) In a positive electrode in the present invention, the above-described lithium transition metal compound oxide may be mixed with at least one of, for example, lithium cobalt oxide, Ni—Co—Mn lithium compound oxide, Ni—Mn—Al lithium compound oxide, Ni—Co—Al lithium compound oxide, Co—Mn lithium compound oxide, and transition metal oxoacid salts containing iron, manganese, or the like (represented by LiMPO₄, Li₂MSiO₄, and LiMBO₃ where M is selected from Fe, Mn, Co, and Ni). In particular, in the case of mixing with lithium cobalt oxide, the substance described in (1) above desirably adheres to the surface.

### EXAMPLES

Hereinafter, a positive electrode active material for a non-aqueous electrolyte secondary battery and the battery will be described. Note that a positive electrode active material for a non-aqueous electrolyte secondary battery and the battery according to the present invention are not limited to the examples below and can be appropriately modified without departing from the spirit and scope of the present invention.

### Example 1

### Preparation of Positive Electrode Active Material

Mixing of Li₂CO₃ and a coprecipitated hydroxide represented by Ni_{0.5}Co_{0.2}Mn_{0.3}(OH)₂ was performed with an Ishikawa-type mixing-grinding mortar such that the molar ratio of Li to all the transition metals was 1.07:1. Subsequently, this mixture was heat-treated in the air atmosphere at 950° C. for 20 hours and then ground to thereby provide a powder of lithium nickel cobalt manganese oxide represented by Li_{1.04}Ni_{0.5}Co_{0.2}Mn_{0.3}O₂, the powder having an average secondary particle size of about 15 μm.

Subsequently, onto 500 g of the powder of lithium nickel cobalt manganese oxide being mixed with a T.K. HIVIS MIX, a solution in which 0.44 g of sodium fluoride was dissolved in 50 mL of pure water was sprayed. Then, drying at 120° C. in the air was performed to thereby provide a positive electrode active material in which sodium fluoride adhered to portions of the surface of the lithium nickel cobalt manganese oxide.

Observation of the obtained positive electrode active material with a scanning electron microscope (SEM) revealed that sodium fluoride having an average particle size of 0.5 nm or less adhered to portions of the surfaces of particles of the lithium nickel cobalt manganese oxide. In addition, measurements by ICP and ion chromatography revealed that the ratio of sodium fluoride to the lithium nickel cobalt manganese oxide particles was 0.08% by mass.

### [Production of Positive Electrode]

The above-described positive electrode active material was kneaded with a carbon black (acetylene black) powder (average particle size: 40 nm) serving as a positive electrode conductive agent and polyvinylidene fluoride (PVdF) serving as a positive electrode binder (binding agent) with a mass ratio of 95:2.5:2.5 in a NMP solution. Thus, positive electrode mixture slurry was prepared. Subsequently, this positive electrode mixture slurry was applied to both surfaces of a positive electrode collector formed of an aluminum foil, and dried. Then, rolling was performed with a rolling roller to thereby provide a positive electrode in which positive electrode mixture layers were formed on both surfaces of the positive electrode collector. Note that the positive electrode mixture layers were formed so as to have a bulk density of 3.3 g/cc.

In this way, four positive electrodes were produced. Subsequently, one of the positive electrodes was not stored in a thermo-hygrostat (30° C., humidity: 50%). The other three positive electrodes were respectively stored in the thermo-hygrostat (30° C., humidity: 50%) for 3, 7, and 14 days. Note that, hereafter, the positive electrode that was not stored in the thermo-hygrostat will be referred to as a positive electrode not exposed to the air; and the positive electrodes stored in the thermo-hygrostat for 3, 7, and 14 days will be respectively referred to as positive electrodes having air exposure periods of 3, 7, and 14 days.

### [Production of Negative Electrode]

Synthetic graphite serving as a negative electrode active material and SBR (styrene-butadiene-rubber) serving as a binder were added to an aqueous solution containing CMC (sodium carboxymethylcellulose) dissolved in water and serving as a thickener, such that the mass ratio of the negative electrode active material, the binder, and the thickener was 98:1:1, and then kneaded to thereby prepare negative electrode slurry. Subsequently, this negative electrode slurry was uniformly applied to both surfaces of a negative electrode collector formed of a copper foil. Then, drying and rolling with a rolling roller were performed.

Furthermore, a negative electrode current collecting tab was attached. Thus, a negative electrode was produced.

### [Preparation of Non-Aqueous Electrolyte]

Lithium hexafluorophosphate (LiPF₆) was dissolved at a concentration of 1.0 mol/liter in a solvent mixture containing ethylene carbonate (EC), ethyl methyl carbonate (EMC), and diethyl carbonate (DEC) mixed in a volume ratio of 3:6:1. Thus, a non-aqueous electrolyte was prepared.

### [Production of Battery]

The thus-obtained positive electrode and negative electrode were wound so as to oppose each other with a separator therebetween to thereby produce an electrode assembly. This electrode assembly was then pressed and deformed so as to have a flat form. Subsequently, within a glovebox under an argon atmosphere, an aluminum laminate casing was sealed so as to contain the flat electrode assembly together with the electrolyte. Thus, a non-aqueous electrolyte secondary battery (battery capacity: 850 mAh) was produced that had a thickness of 3.6 mm, a width of 3.5 cm, and a length of 6.2 cm.

Hereafter, such batteries produced in this way will be referred to as Battery A1. Note that the Battery A1 includes four batteries: specifically, a battery including the positive electrode not exposed to the air, and batteries including the positive electrodes having air exposure periods of 3, 7, and 14 days.

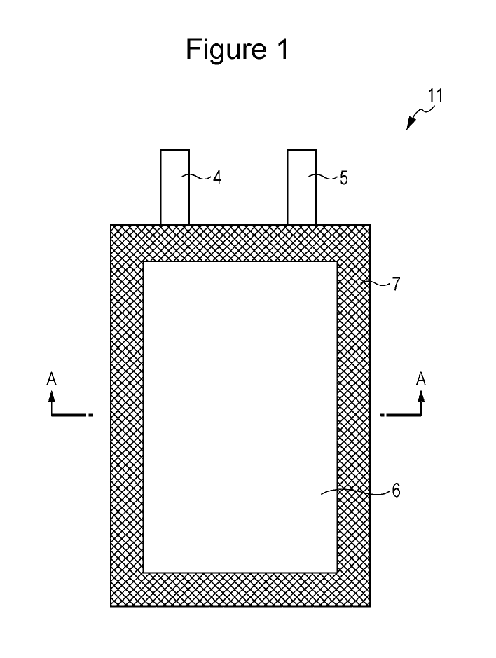

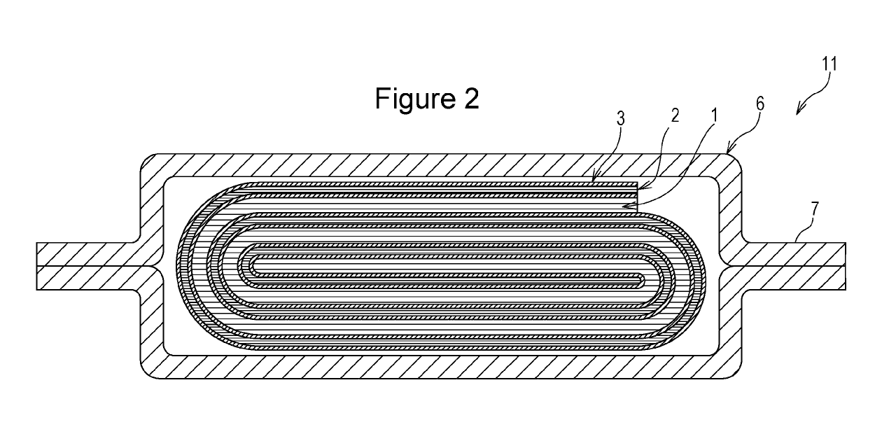

As illustrated in FIG. 1 and FIG. 2, the specific structure of such a non-aqueous electrolyte secondary battery 11 is as follows: a positive electrode 1 and a negative electrode 2 are disposed so as to oppose each other with a separator 3 therebetween. A flat electrode assembly including the positive and negative electrodes 1 and 2 and the separator 3 is impregnated with the non-aqueous electrolyte. The positive electrode 1 and the negative electrode 2 are respectively connected to a positive electrode current collecting tab 4 and a negative electrode current collecting tab 5 to thereby provide a secondary-battery structure allowing charging and discharging. Note that the electrode assembly is placed within a housing space of an aluminum laminate casing 6 having a closed portion 7 constituted by heat-sealed peripheries.

### [Production of Three-Electrode Cell]

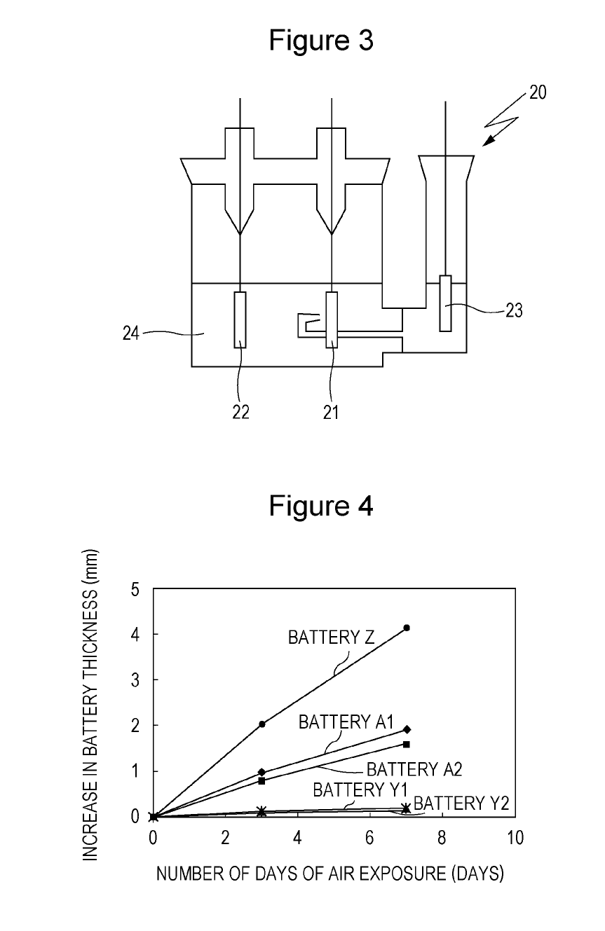

In addition to the batteries, a three-electrode cell 20 illustrated in FIG. 3 was produced. At this time, the above-described positive electrode (positive electrode not exposed to the air) was used as a working electrode 21; and a counter electrode 22 serving as a negative electrode and a reference electrode 23 were formed of metal lithium. A non-aqueous electrolyte 24 had the same composition as above.

Hereafter, the thus-produced cell will be referred to as Cell A1.

### Example 2

A battery was produced as in Example 1 above except that, in the preparation of the positive electrode active material, the amount of sodium fluoride was changed to 2.2 g (the ratio of sodium fluoride to the lithium nickel cobalt manganese oxide particles was 0.40% by mass).

Hereafter, such batteries produced in this way will be referred to as Battery A2. Note that Example 2 was also performed to produce a positive electrode that was not stored in a thermo-hygrostat (30° C., humidity: 50%) and positive electrodes that were stored in the thermo-hygrostat (30° C., humidity: 50%) for 3, 7, and 14 days. Accordingly, as with the Battery A1, the Battery A2 includes a battery including the positive electrode not exposed to the air, and batteries including the positive electrodes having air exposure periods of 3, 7, and 14 days (in total, four batteries). Note that, similarly, Batteries Z, Y1, and Y2 described below include four batteries and descriptions thereof are omitted below.

In addition, a three-electrode cell was produced as in Example 1 above except that a positive electrode containing such a positive electrode active material was used.

Hereafter, the thus-produced cell will be referred to as Cell A2. Note that, in Example 2, the positive electrode not exposed to the air was also used as the positive electrode. This was the same as in Cells Z, Y1, and Y2 described below and descriptions thereof are omitted below.

### Comparative Example

A battery was produced as in Example 1 above except that, in the preparation of the positive electrode active material, sodium fluoride was not made to adhere to the surface of lithium nickel cobalt manganese oxide.

Hereafter, such batteries produced in this way will be referred to as Battery Z.

In addition, a three-electrode cell was produced as in Example 1 above except that a positive electrode containing such a positive electrode active material was used.

Hereafter, the thus-produced cell will be referred to as Cell Z.

### Reference Example 1

A battery was produced as in Example 2 above except that, in the preparation of the positive electrode active material, Ni_{0.5}Co_{0.2}Mn_{0.3}(OH)₂ was replaced by Ni_{0.33}Co_{0.34}Mn_{0.33}(OH)₂ (in the lithium nickel cobalt manganese oxide, the nickel content and the manganese content were the same in terms of moles).

Hereafter, such batteries produced in this way will be referred to as Battery Y1.

In addition, a three-electrode cell was produced as in Example 2 above except that a positive electrode containing such a positive electrode active material was used.

Hereafter, the thus-produced cell will be referred to as Cell Y1.

### Reference Example 2

A battery was produced as in Reference example 1 above except that sodium fluoride was not made to adhere to the surface of lithium nickel cobalt manganese oxide.

Hereafter, such batteries produced in this way will be referred to as Battery Y2.

In addition, a three-electrode cell was produced as in Reference example 1 above except that a positive electrode containing such a positive electrode active material was used.

Hereafter, the thus-produced cell will be referred to as Cell Y2.

### (Experiment 1)

The above-described Batteries A1, A2, Z, Y1, and Y2 were subjected to charging, discharging, and the like under the following conditions in order to determine the charge storage property of the batteries at high temperature. The results are described in Table 1.

### [Charge-Discharge Conditions]

Charge Conditions

Conditions: performing constant-current charging at a current of 1.0 It (850 mA) until the battery voltage reaches 4.4 V, and subsequently performing constant-voltage charging until the current reaches 0.05 It (42.5 mA).

Discharge Conditions

Conditions: performing constant-current discharging at a current of 1.0 It (850 mA) until the battery voltage reaches 2.75 V.

Interruption

An interval between charging and discharging was set to 10 minutes.

### [Method of Determining Charge Storage Property at High Temperature]

First, charging-discharging was performed once under the same conditions as the charge-discharge conditions. Subsequently, charging was performed under the same conditions and then battery thickness (battery thickness before charge storage) was measured. After that, the battery was stored in a thermostat at 80° C. for 2 days. Immediately after the battery was taken out, battery thickness (battery thickness after charge storage) was measured.

Formula (1) below was used to calculate an increase in the battery thickness during storage (hereafter, sometimes simply referred to as increase in battery thickness); and, regarding the Batteries A1, A2, Z, Y1, and Y2, the relationship between the number of days of air exposure and the increase in the battery thickness was determined. The results are illustrated in FIG. 4.

Increase in battery thickness (mm)=Battery thickness after charge storage−Battery thickness before charge storage (1)

Furthermore, from the gradients in FIG. 4, a rate of increase in battery thickness due to air exposure (mm/day) was determined. The results are described in Table 1. Note that, in FIG. 4, the batteries including positive electrodes having an air exposure period of 14 days are not illustrated. The gradients of these batteries were substantially the same as those of the batteries including positive electrodes having an air exposure period of 7 days.

### (Experiment 2)

The above-described Cells A1, A2, Z, Y1, and Y2 were subjected to charging and discharging under the following conditions in order to determine the single-electrode discharge capacity. The results are described in Table 1.

### [Charge-Discharge Conditions]

The Cells A1, A2, Z, Y1, and Y2 were subjected to constant-current charging at a current density of 0.75 mA/cm² until the voltage reached 4.5 V (vs. Li/Li⁺), further subjected to constant-voltage charging at a constant voltage of 4.5 V (vs. Li/Li⁺) until the current density reached 0.04 mA/cm², and subsequently subjected to constant-current discharging at a current density of 0.75 mA/cm² until the voltage reached 2.5 V (vs. Li/Li⁺).

TABLE 1

| | Composition of | | Single- | Rate of |
|---|---|---|---|---|
| | base material | Adhesion | electrode | increase in |
| | of positive | amount of | (three-electrode | battery thickness |
| Bat- | electrode active | sodium | cell) discharge | due to air |
| tery | material | fluoride | capacity | exposure |
| (Cell) | Ni:Co:Mn | (% by mass) | (mAh/g) | (mm/day) |
| A1 | 5:2:3 | 0.08 | 190 | 0.28 |
| A2 | | 0.40 | 187 | 0.23 |
| Z | | — | 190 | 0.60 |
| Y1 | 33:34:33 | 0.40 | 178 | 0.03 |
| Y2 | | — | 180 | 0.03 |

From Table 1, comparison between the Batteries A1, A2, and Z containing lithium nickel cobalt manganese oxide at least containing nickel and manganese such that the nickel is contained in a higher content than the manganese in terms of moles reveals the following: the rate of increase in battery thickness due to air exposure is decreased in the Batteries A1 and A2 in which sodium fluoride is made to adhere to the surface of lithium nickel cobalt manganese oxide, compared with the Battery Z in which sodium fluoride is not made to adhere to the surface. The reason for this is probably as follows.

In the Battery Z in which sodium fluoride is not made to adhere to the surface of lithium nickel cobalt manganese oxide, exposure to the air in the presence of trivalent nickel causes a reaction between moisture in the air and lithium nickel cobalt manganese oxide. As a result, lithium hydroxide or lithium carbonate is generated and the amount of gas generated is increased. In contrast, in the Batteries A1 and A2 in which sodium fluoride is made to adhere to the surface of lithium nickel cobalt manganese oxide, even when the batteries are exposed to the air in the presence of trivalent nickel, the reaction between moisture in the air and lithium nickel cobalt manganese oxide is suppressed. As a result, generation of lithium hydroxide or lithium carbonate is probably suppressed and hence the amount of gas generated tends not to increase.

On the other hand, comparison between the Batteries Y1 and Y2 containing lithium nickel cobalt manganese oxide at least containing nickel and manganese such that the nickel content and the manganese content are the same in terms of moles reveals the following: the rate of increase in battery thickness due to air exposure is substantially the same in the Battery Y1 in which sodium fluoride is made to adhere to the surface of lithium nickel cobalt manganese oxide and the Battery Y2 in which sodium fluoride is not made to adhere to the surface. The reason for this is as follows. Since the nickel content and the manganese content are the same in terms of moles, lithium nickel cobalt manganese oxide does not contain trivalent nickel. Accordingly, exposure to the air does not result in occurrence of the reaction between moisture in the air and lithium nickel cobalt manganese oxide.

With consideration of the foregoing, it may be sufficient to use lithium nickel cobalt manganese oxide not containing trivalent nickel (the nickel content and the manganese content are the same in terms of moles or the nickel content is lower than the manganese content in terms of moles). However, as is obvious from Table 1, in the cases of using such lithium nickel cobalt manganese oxide, the discharge capacity is decreased, compared with the cases of using lithium nickel cobalt manganese oxide containing trivalent nickel. Specifically, this is obvious from the fact that the Cells A1, A2, and Z have discharge capacities of 187 to 190 mAh/g, whereas the Cells Y1 and Y2 have discharge capacities of 178 to 180 mAh/g. Accordingly, in order to increase discharge capacity while generation of gas is suppressed, a configuration according to the present invention needs to be employed.

Note that the Cell A1 has the same discharge capacity as the Cell Z, whereas the Cell A2 has a slightly lower discharge capacity than the Cell Z. The reason for this is probably as follows: since the compound having a low electron conductivity adheres to the surface, the discharge performance is degraded. Accordingly, from the standpoint of increasing discharge capacity, excessively large amount of sodium fluoride is not preferred.

### INDUSTRIAL APPLICABILITY

The present invention is expected to be applied to, for example, driving power sources for mobile information terminals such as cellular phones, notebook computers, and smart phones, and high-power driving power sources for HEVs and power tools.

### REFERENCE SIGNS LIST

1: positive electrode
2: negative electrode
3: separator
4: positive electrode current collecting tab
5: negative electrode current collecting tab
6: aluminum laminate casing
7: closed portion
11: non-aqueous electrolyte secondary battery

1. A positive electrode active material for a non-aqueous electrolyte secondary battery, comprising:
a lithium transition metal compound oxide at least containing nickel and manganese such that the nickel is contained in a higher content than the manganese in terms of moles; and
sodium fluoride adhering to a surface of the lithium transition metal compound oxide.

2. The positive electrode active material for a non-aqueous electrolyte secondary battery according to claim 1, wherein the lithium transition metal compound oxide contains cobalt.

3. The positive electrode active material for a non-aqueous electrolyte secondary battery according to claim 1, wherein a ratio of the nickel to a total transition-metal amount of the lithium transition metal compound oxide is 50 mol % or more.

4. A non-aqueous electrolyte secondary battery comprising:
a positive electrode containing the positive electrode active material according to claim 1;
a negative electrode containing a negative electrode active material;
a separator disposed between the positive electrode and the negative electrode; and
a non-aqueous electrolyte.

5. The non-aqueous electrolyte secondary battery according to claim 4, wherein an electrode assembly including the positive electrode, the negative electrode, and the separator has a flat form.

6. A non-aqueous electrolyte secondary battery comprising:
a positive electrode containing the positive electrode active material according to claim 2;
a negative electrode containing a negative electrode active material;
a separator disposed between the positive electrode and the negative electrode; and
a non-aqueous electrolyte.

7. A non-aqueous electrolyte secondary battery comprising:
a positive electrode containing the positive electrode active material according to claim 3;
a negative electrode containing a negative electrode active material;
a separator disposed between the positive electrode and the negative electrode; and
a non-aqueous electrolyte.
